(19) United States
(12) Patent Application Publication
(10) Pub. No.: US 2011/0251708 A1
(43) Pub. Date: Oct. 13, 2011

(54) METHOD FOR PLANNING PRODUCTION SCHEDULE OF EQUIPMENT AND ASSOCIATED COMPUTER READABLE MEDIUM

(76) Inventors: Wei-Jun Chen, Taichung County (TW); Yun-Zong Tian, Taichung County (TW); Yij-Chieh Chu, Taipei County (TW); Yi-Feng Lee, Taipei County (TW)

(21) Appl. No.: 12/783,510

(22) Filed: May 19, 2010

(30) Foreign Application Priority Data
Apr. 7, 2010 (TW) 099110736

(51) Int. Cl. G06F 19/00

(52) U.S. Cl. 700/102; 700/100

(57) ABSTRACT

A method for planning a production schedule of equipment includes: receiving information about a material replacement of the equipment; and determining a target production schedule of the equipment according to the information about the material replacement of the equipment, wherein the target production schedule includes an idle period, and during the idle period, the equipment stops manufacturing under a normal state.

### BACKGROUND OF THE INVENTION

1. Field of the Invention

The present invention relates to a method for planning a production schedule of equipment, and more particularly, to a method for planning a production schedule of equipment on condition that a production delay is allowable, and an associated computer readable medium.

2. Description of the Prior Art

During a process in which a semiconductor equipment is working, acid in an acid tank of the semiconductor equipment needs to be replaced under the following conditions: when a preventive maintenance of the semiconductor equipment is being processed; after the acid in the acid tank has been used to manufacture productions whose amount reaches a specific amount; and when the period in which the acid is placed in the acid tank reaches a specific time. Ideally, when the acid in the tank is replaced after being used to manufacture productions whose amount reaches the specific amount, the acid will have the best usage efficiency. The prior art method for planning the production schedule of the semiconductor equipment, however, generally maximizes the throughput of the semiconductor equipment without considering the acid usage efficiency. Therefore, the manufacturing cost may be increased due to the low acid usage efficiency. Please refer to FIG. 1. FIG. 1 is a prior art diagram illustrating a method for planning the production schedule of the semiconductor equipment. As shown in FIG. 1, if the production schedule is planned for maximizing the throughput of the semiconductor equipment, the acid in the tank needs to be replaced a short time before the preventive maintenance of the semiconductor equipment, because the acid has been used for manufacturing productions whose amount reaches the specific amount. Therefore, the new acid can only be used to manufacture a batch of product B because this new acid needs to be replaced due to the preventive maintenance, causing low acid usage efficiency.

### SUMMARY OF THE INVENTION

It is therefore an objective of the present invention to provide a method for planning a production schedule of equipment where a production delay is allowable, and an associated computer readable medium, to solve the above-mentioned problem.

According to one embodiment of the present invention, a method for planning a production schedule of equipment comprises: receiving information about a material replacement of the equipment; and determining a target production schedule of the equipment according to the information about the material replacement of the equipment, wherein the target production schedule comprises an idle period, and during the idle period, the equipment stops manufacturing under a normal state.

According to another embodiment of the present invention, a computer readable medium is disclosed. The computer readable medium stores a program code which is used for planning a production schedule of equipment, and when the program code is executed by a processor, the program code executes the following steps: receiving information about a material replacement of the equipment; and determining a target production schedule of the equipment according to the information about the material replacement of the equipment, wherein the target production schedule comprises an idle period, and during the idle period, the equipment stops manufacturing under a normal state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a prior art diagram illustrating a method for planning the production schedule of the semiconductor equipment.

FIG. 2 is a flowchart of a method for planning a production schedule of semiconductor equipment according to one embodiment of the present invention.

FIG. 3 is a diagram illustrating a production schedule of semiconductor equipment according to one embodiment of the present invention.

FIG. 4 is a diagram illustrating a computer readable medium according to one embodiment of the present invention.

### DETAILED DESCRIPTION

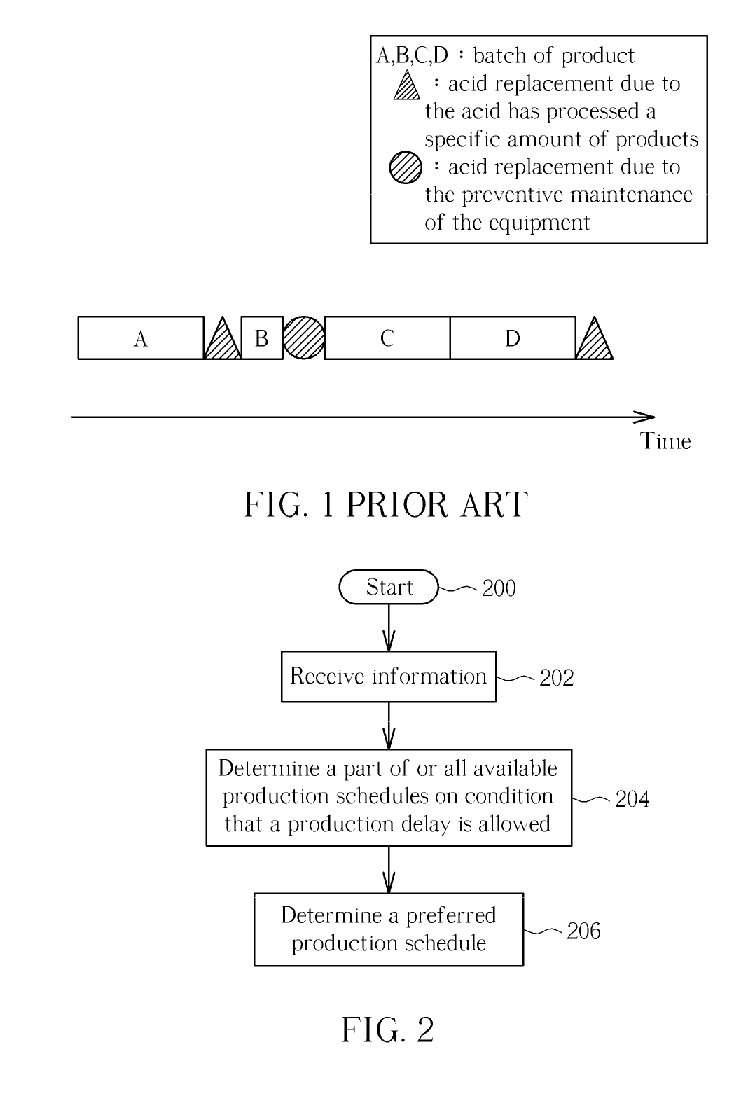

Please refer to FIG. 2. FIG. 2 is a flowchart of a method for planning a production schedule of semiconductor equipment according to one embodiment of the present invention. Referring to FIG. 2, the method for planning the production schedule of the semiconductor equipment is described as follows:

In Step 200, the process starts. In Step 202, the process receives information about semiconductor equipment, batches of products and material replacement of the semiconductor equipment. For example, the semiconductor equipment and batches of products information comprises a number of equipment which can be used for manufacturing, whether the equipment allows the production delay, an amount of each batch of product, and the time required to process the batch of product . . . etc; and the material replacement information comprises the timing of preventive maintenances of the semiconductor equipment, wherein after a certain amount of the products are manufactured by the semiconductor equipment the material needs to be replaced, and after a certain time in which the material is used the material needs to be replaced.

Step 204 determines a part of or all available production schedules on the condition that a production delay is allowable according to the above-mentioned information about semiconductor equipment, batches of products and material replacement of the semiconductor equipment. Finally, in Step 206, a genetic algorithm is applied to analyze the available production schedules determined in Step 204 to obtain a preferred production schedule which serves as a target production schedule of the semiconductor equipment.

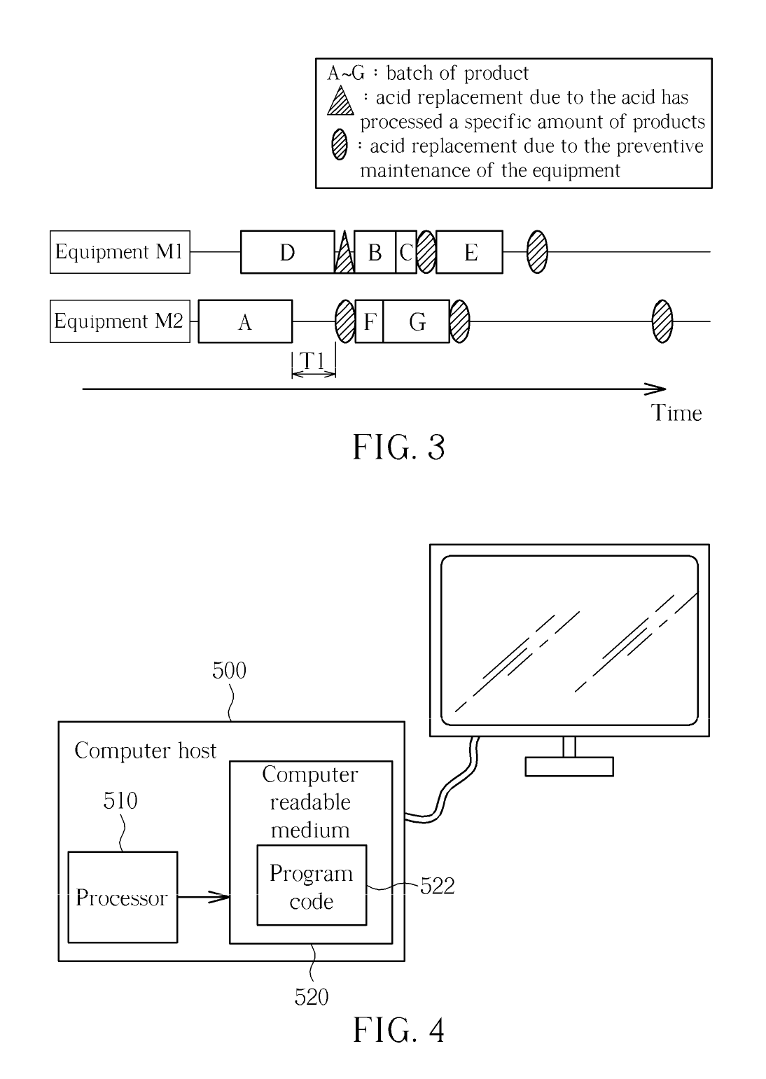

An example is taken to illustrate Steps 202˜206: assuming that the received information in Step 202 indicates that two available equipment M1 and M2 can be used to manufacture the product, the equipment M1 does not allow the production delay and the equipment M2 allows the production delay, seven batches of wafers A, B, C, D, E, F, G need to be processed, and the acid (i.e., the material) needs to be replaced after the acid in the acid tank has been used to process wafers whose amount reaches 1000 pieces, then one of the available production schedule determined in Step 204 is shown in FIG. 3. Referring to FIG. 3, because the equipment M2 allows the production delay, an idle period T1 can be arranged after the batch of wafer A is completely processed. The batch of wafer F starts to be processed after the preventive maintenance of the equipment is finished.

In addition, as shown in FIG. 3, in practice the batch of wafer F can be processed during the idle period T1 by the equipment M2. The reason is given as follows: assume that after the batch of wafer A is completely processed, the acid in the acid tank has been used to process 990 pieces of wafers, the equipment M2 can process 50 pieces of wafers during the period T1, and the batch of wafer F has 40 pieces of wafers. Then, if the batch of wafer F is processed immediately following the processing of the batch of wafer A (i.e., during the period T1), the acid in the acid tank needs to be replaced when 10 pieces of wafers (of the batch of wafer F) is processed because the acid has processed 1000 pieces of wafers. Then, after the acid replacement, the new acid needs to be replaced again after processing only 30 pieces of wafers due to the preventive maintenance of the equipment, causing low acid usage efficiency. Therefore, if the batch of wafer is arranged to be processed after the preventive maintenance of the equipment M2, the acid replacement during the period T1 can be avoided. A frequency of the acid replacement of the equipment M2 is thereby decreased, and the newly injected acid during the preventive maintenance can also be used to process more wafers.

In addition, although postponing the batch of wafer F can lower the cost of the acid, the throughput of the equipment M2 may be decreased due to the idle period T1. Therefore, considering the increased cost due to the throughput of the equipment M2 and the decreased cost due to the high acid usage efficiency, in Step 206, a cost analysis is performed upon the available production schedules to determine which target production schedule has a lowest cost.

In addition, the flow shown in FIG. 2 can be executed by a program code stored in a computer readable medium. For details, please refer to FIG. 4. A computer host 400 comprises at least a processor 410 and a computer readable medium 420, where the computer readable medium can be a hard disk or any other storage device, and the computer readable medium 420 stores a program code 422. When the processor executes the program code 422, the computer host 400 executes the steps shown in FIG. 2.

Briefly summarized, in the method for planning a production schedule of equipment and associated computer readable medium of the present invention, an idle period is allowed to be arranged in the production schedule. During the idle period, the equipment stops manufacturing under a normal state to decrease a frequency of the acid replacement of the equipment and increase the amount of the products which are processed by the newly injected acid during the preventive maintenance.

Those skilled in the art will readily observe that numerous modifications and alterations of the device and method may be made while retaining the teachings of the invention.

What is claimed is:

1. A method for planning a production schedule of equipment, comprising:
receiving information about a material replacement of the equipment; and
determining a target production schedule of the equipment according to the information about the material replacement of the equipment;
wherein the target production schedule comprises an idle period, and during the idle period, the equipment stops manufacturing under a normal state.

2. The method of claim 1, wherein the information about the material replacement of the equipment comprises a time of a preventive maintenance of the equipment, and information about when the acid in the acid tank has been used to manufacture productions whose amount reaches a specific amount; and the step of determining the target production schedule of the equipment comprises:
arranging the idle period before the time of the preventive maintenance of the equipment to decrease a frequency of the material replacement of the equipment.

3. The method of claim 1, wherein the information about the material replacement of the equipment comprises a time of a preventive maintenance of the equipment, and information about when the acid in the acid tank has been used to manufacture productions whose amount reaches a specific amount; and the step of determining the target production schedule of the equipment comprises:
arranging the idle period before the time of the preventive maintenance of the equipment to increase an amount of the products which are processed by new inputted material during the preventive maintenance.

4. The method of claim 1, wherein the step of determining the target production schedule of the equipment comprises:
determining the target production schedule of the equipment according to the information about the material replacement of the equipment, an increased cost due to the arrangement of the idle period, and a decreased cost due to a lower frequency of the material replacement of the equipment.

5. A computer readable medium storing a program code which is used for planning a production schedule of equipment, wherein when the program code is executed by a processor, the program code executes the following steps:
receiving information about a material replacement of the equipment; and
determining a target production schedule of the equipment according to the information about the material replacement of the equipment;
wherein the target production schedule comprises an idle period, and during the idle period, the equipment stops manufacturing under a normal state.

6. The computer readable medium of claim 5, wherein the information about the material replacement of the equipment comprises a time of a preventive maintenance of the equipment, and information about when the acid in the acid tank has been used to manufacture productions whose amount reaches a specific amount; and the step of determining the target production schedule of the equipment comprises:
arranging the idle period before the time of the preventive maintenance of the equipment to decrease a frequency of the material replacement of the equipment.

7. The computer readable medium of claim 5, wherein the information about the material replacement of the equipment comprises a time of a preventive maintenance of the equipment, and information about when the acid in the acid tank has been used to manufacture productions whose amount reaches a specific amount; and the step of determining the target production schedule of the equipment comprises:
arranging the idle period before the time of the preventive maintenance of the equipment to increase an amount of the products which are processed by new inputted material during the preventive maintenance.

8. The computer readable medium of claim 5, wherein the step of determining the target production schedule of the equipment comprises:
determining the target production schedule of the equipment according to the information about the material replacement of the equipment, an increased cost due to the arrangement of the idle period, and a decreased cost due to a lower frequency of the material replacement of the equipment.
